(19) United States
(12) Patent Application Publication
(10) Pub. No.: US 2025/0310935 A1
(43) Pub. Date: Oct. 2, 2025

(54) OPTIMIZING COVERAGE AND LATENCY OF ULTRA-WIDEBAND DEVICES

(71) Applicant: NEC Laboratories America, Inc., Princeton, NJ (US)

(72) Inventors: Ravi Kailasam Rajendran, Colonia, NJ (US); Murugan Sankaradas, Dayton, NJ (US); Srimat Chakradhar, Manalapan, NJ (US)

(21) Appl. No.: 19/096,953

(22) Filed: Apr. 1, 2025

Related U.S. Application Data
(60) Provisional application No. 63/572,994, filed on Apr. 2, 2024.

(51) Int. Cl. H04W 64/00; H04W 24/02

(52) U.S. Cl. CPC H04W 64/006; H04W 24/02

(57) ABSTRACT

Systems and methods for optimizing latency and coverage in ultra-wideband devices. Connections can be established between beacons through signal transmissions. Positions of the beacons at a discovered area can be refined within a topology having support beacons that fill gaps of coverage between the beacons based on synchronized signal handshakes. Latency and coverage of the beacons can be optimized by prioritizing beacons within the topology based on proximity and signal strength.

### RELATED APPLICATION INFORMATION

This application claims priority to U.S. Provisional App. No. 63/572,994, filed on Apr. 2, 2024, incorporated herein by reference in its entirety.

### BACKGROUND

### Technical Field

The present invention relates to ultra-wideband devices and more particularly optimizing coverage and latency of ultra-wideband devices.

### Description of the Related Art

Localization systems use diverse sensing technologies and algorithmic techniques depending on specific situations and environments.

Indoor localization is the ability to determine the position of objects or people within enclosed spaces. Indoor localization has attracted significant attention in recent years due to its potential applications in areas such as smart buildings, logistics, and healthcare. However, traditional methods for indoor localization face limitations such as dependence on dedicated infrastructure or inadequate accuracy.

On the other hand, outdoor localization relies on the signals from Global Navigation Satellite Systems (GNSS) like Global Positioning System (GPS). These systems necessitates clear line of sight and clear operational frequencies for accurate positioning.

### SUMMARY

According to an aspect of the present invention, a computer-implemented method for optimizing latency and coverage of ultra-wideband devices is provided, including, establishing connections between beacons through signal transmissions, refining positions of the beacons at a discovered area within a topology having support beacons that fill gaps of coverage between the beacons based on synchronized signal handshakes, and optimizing the latency and coverage of the beacons by prioritizing beacons within the topology based on proximity and signal strength.

According to another aspect of the present invention, a system is provided for optimizing latency and coverage of ultra-wideband devices is provided, including, establishing connections between beacons through signal transmissions, refining positions of the beacons at a discovered area within a topology having support beacons that fill gaps of coverage between the beacons based on synchronized signal handshakes, and optimizing the latency and coverage of the beacons by prioritizing beacons within the topology based on proximity and signal strength.

According to yet another aspect of the present invention, a non-transitory computer program product including a computer-readable storage medium including a program code for optimizing latency and coverage of ultra-wideband devices, wherein the program code when executed on a computer causes the computer to perform operations having establishing connections between beacons through signal transmissions, refining positions of the beacons at a discovered area within a topology having support beacons that fill gaps of coverage between the beacons based on synchronized signal handshakes, and optimizing the latency and coverage of the beacons by prioritizing beacons within the topology based on proximity and signal strength.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level overview of a computer-implemented method for optimizing latency and coverage of ultra-wideband device, in accordance with an embodiment of the present invention;

FIG. 2 is a block diagram showing an interconnected grid of beacons controlled by a core controller, in accordance with an embodiment of the present invention;

FIG. 3 is a block diagram showing an interconnected grid of beacons controlled by a core controller, in accordance with an embodiment of the present invention;

FIG. 4, is a block diagram showing a scenario of coverage range between beacons with ranging variance resulting in localization errors;

FIG. 5 is a block diagram showing structures of the beacons, in accordance with an embodiment of the present invention;

FIG. 6 is a block diagram showing a system implementing a practical application of extending wireless network connectivity, in accordance with an embodiment of the present invention;

FIG. 7 is a block diagram showing a system implementing a practical application of rescuing people within a location, in accordance with an embodiment of the present invention;

FIG. 8 is a block diagram showing a system implementing a practical application of controlling an autonomous vehicle, in accordance with an embodiment of the present invention;

FIG. 9 is a block diagram showing a system implementing optimizing latency and coverage of ultra-wideband devices, in accordance with an embodiment of the present invention; and

FIG. 10 is a block diagram showing a multi-layer framework for a computing system for optimizing latency and coverage for ultra-wideband devices, in accordance with an embodiment of the present invention.

### DETAILED DESCRIPTION OF PREFERRED EMBODIMENTS

In accordance with embodiments of the present invention, systems and methods are provided to/for optimizing latency and coverage of ultra-wideband (UWB) devices.

In an embodiment, connections can be established between beacons through signal transmissions. Positions of the beacons at a discovered area can be refined within a topology having support beacons that fill gaps of coverage between the beacons based on synchronized signal handshakes. Latency and coverage of the beacons can be optimized by prioritizing beacons within the topology based on proximity and signal strength.

Achieving scalability while having the ability to extend coverage over long ranges is an ongoing issue in the domain of real-time location systems (RTLS). However, traditional methods utilizing high-frequency signals are limited due to signal attenuation over extended distances. Striking a balance between the desired scalability and the inherent constraints imposed by signal characteristics is challenging. An approach involving alternative frequency bands and innovative signal processing techniques is needed to overcome these limitations for scalable, long-range solutions.

There are two distinct variants in indoor positioning systems: infrastructure-based and infrastructure-free localization. Infrastructure-based localization involves the deployment of dedicated infrastructure elements, such as beacons or access points, to enable positioning. This approach typically provides higher accuracy and reliability, especially in outdoor environments where line-of-sight to satellites is not obstructed. Infrastructure-based localization has also proven to be viable in indoor environments.

Ultra-wideband (UWB) technology has emerged as a strong candidate for location-aware applications due to its high data rates and exceptional ranging accuracy. UWB offers centimeter-level precision, but its coverage area is limited. To achieve real-time localization with low latency, selecting the most appropriate device pairs for ranging sessions (which take approximately 200 milliseconds) is crucial. High beacon communication overhead can significantly increase latency, resulting in outdated location data for mobile beacons.

Outdoor localization relies on the signals from Global Navigation Satellite Systems (GNSS) like Global Positioning System (GPS). The foundation of these localization systems is based entirely on these constellation of satellites orbiting Earth, emitting signals that the GPS receivers on the ground receive signals and triangulate to determine their precise position. Outdoor navigation can provide remarkable accuracy and global coverage depending on the location on earth, thus making it indispensable for navigation, and spatial mapping. Outdoor localization systems, especially the ones relying on Global Navigation Satellite Systems (GNSS), necessitate a clear Line of Sight (LoS) to ensure the optimal positioning. This LoS requirement is underscored by research findings, which emphasizes the importance of unobstructed paths for accurate positioning.

In addition to the line-of-sight requirements, frequency of operation is also a major factor. For instance, in GNSS, including the commonly used GPS, primarily operates at lower frequency bands between 1.5 gigahertz (GHz) and 3 GHz. GNSS transmit at two carrier frequencies: L1 (1575.42 megahertz [MHz]) and L2 (1227.6 MHz). Even here, L2 is better than L1 frequency due to its penetrating nature. The preference for lower frequencies is rooted in their superior ability to penetrate obstacles like clouds, trees, and buildings, enhancing signal reliability and maintaining LoS connectivity. In the evolution of GNSS technology, newer satellites are designed to operate at even lower frequencies, such as 1176 MHz, further improving performance in challenging outdoor environments. This strategic frequency selection contributes to the robustness of outdoor localization systems, as they are less susceptible to interference from the objects in atmosphere, enabling accurate and reliable positioning even in complex terrains.

Indoor localization, on the other hand, can be infrastructure-based and infrastructure-free. Infrastructure-based indoor localization systems leverage existing infrastructure, making them easier to deploy compared to alternative methods. However, these systems hinge on Line of Sight (LoS) between the localization infrastructure and the target device. Consequently, non-Line of Sight (NLoS) scenarios can impede their effectiveness. Planning and, in some cases, fingerprinting may be necessary to enhance accuracy. In such environments, Ultra-Wideband (UWB) technology can be a promising candidate due to its ability to transmit data over a broad spectrum, allowing for precise distance measurements and improved performance in indoor settings.

However, more challenges emerge in infrastructure-free approach. Infrastructure-free indoor localization faces many technical challenges, which ultra-wideband sensors cannot solve. The body shadowing effect, caused by the human body obstructing the direct line of sight between UWB devices, poses a significant hurdle. This effect becomes more pronounced in dynamic environments where walls and obstacles can alter signal propagation. Multi-path signals, resulting from signal reflections off surfaces, further complicate localization accuracy. Additionally, UWB devices also face issues regarding the accuracy of distance measurements, antenna orientation of the devices, time varying nature of ranging measurements, etc. The inability to obtain the true distance between two ranging devices due to these challenges lowers the precision of UWB-based systems. Additionally, the lack of easy generalizability across diverse indoor environments adds complexity to achieving robust infrastructure-free localization.

The energy propagation characteristics of the signals used in High Frequency (HF) and Low Frequency (LF) solutions affect their effectiveness. High frequencies inherently lose energy more rapidly than lower frequencies. HF signals also exhibit higher absorption rates, especially in environments where temperature and other conditions play a role. Higher frequencies (shorter wavelength) interact with the electrons in the atoms and molecules more than their lower frequency counterparts. Radio frequency (RF) waves penetration also depends on the material of the objects. Metals block RF waves more than wood or brick walls.

Moreover, the electromagnetic (EM) frequency's impact on body surfaces is significant, with higher frequencies experiencing stronger absorption. This characteristic restricts the ability of HF signals to penetrate the human body effectively, limiting their application in scenarios where precise localization through body obstruction is necessary. In contrast, LF signals, with their lower energy loss and absorption rates, present advantages in overcoming these challenges for infrastructure-free indoor localization.

For an efficient indoor localization system with higher precision at higher update rate is limited by these technologies due to their characteristics. Techniques can be built to minimize this challenges but may fail to overcome the physical limitation on how RF waves interact with matter.

The present embodiments solve these issues with an infrastructure free localization system and techniques using UWB sensing technology that enhances both the coverage and responsiveness.

The present embodiments proposes at least two strategies:

Coverage Extension through Support beacons: The present embodiments introduce the concept of support beacons, strategically placed UWB devices that augment the signal from existing anchor beacons. This strategy effectively expands the coverage area and ensures reliable localization even in obstructed or signal-challenged environments.

Intelligent Beacon Selection for Reduced Latency: Recognizing the impact of beacon selection on system latency, the present embodiments propose an intelligent algorithm that dynamically selects the optimal combination of anchor and support beacons for each localization estimation. This approach prioritizes beacons based on factors like signal strength, proximity to the target device, and network topology, thereby minimizing communication overhead and ensuring timely location updates.

The present embodiments seamlessly combine coverage extension and intelligent beacon selection, effectively overcoming some of the limitations of traditional UWB localization while using its inherent strengths. The resulting infrastructure-free, high-accuracy, and low-latency solution holds a significant promise towards indoor localization applications. The present embodiments address the challenges in UWB-based localization solutions (both outdoor and indoor localization), enabling reliable and rapid location tracking in diverse environments.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

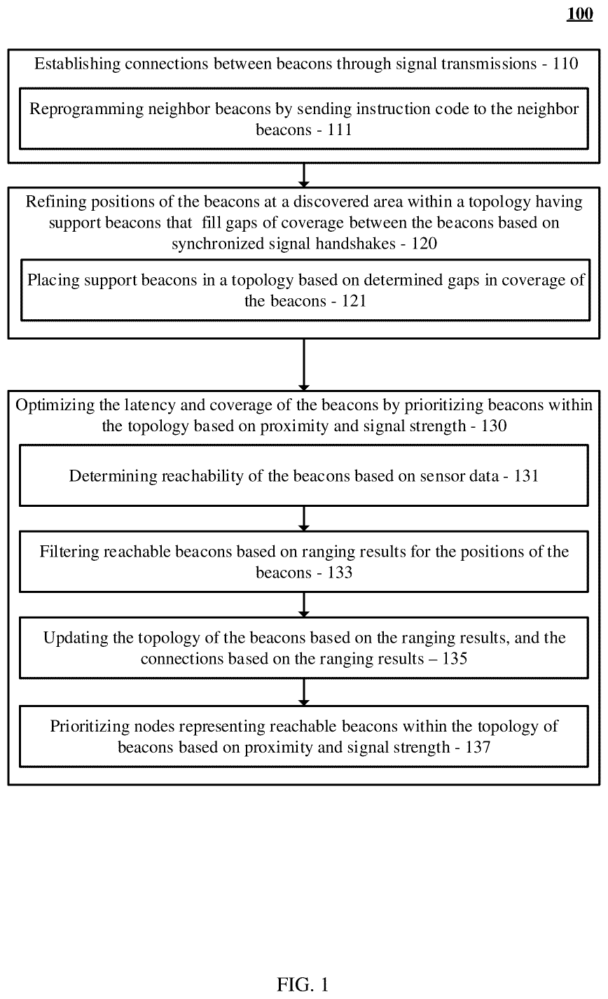

Referring now in detail to the figures in which like numerals represent the same or similar elements and initially to FIG. 1, a high-level overview of a computer-implemented method for optimizing latency and coverage of ultra-wideband devices is illustratively depicted as a flowchart in accordance with one embodiment of the present invention.

In an embodiment, connections can be established between beacons through signal transmissions. Positions of the beacons at a discovered area can be refined within a topology having support beacons that fill gaps of coverage between the beacons based on synchronized signal handshakes. Latency and coverage of the beacons can be optimized by prioritizing beacons within the topology based on proximity and signal strength.

In block 110, connections can be established between beacons, including mobile beacons, support beacons, and anchor beacons, through signal transmissions.

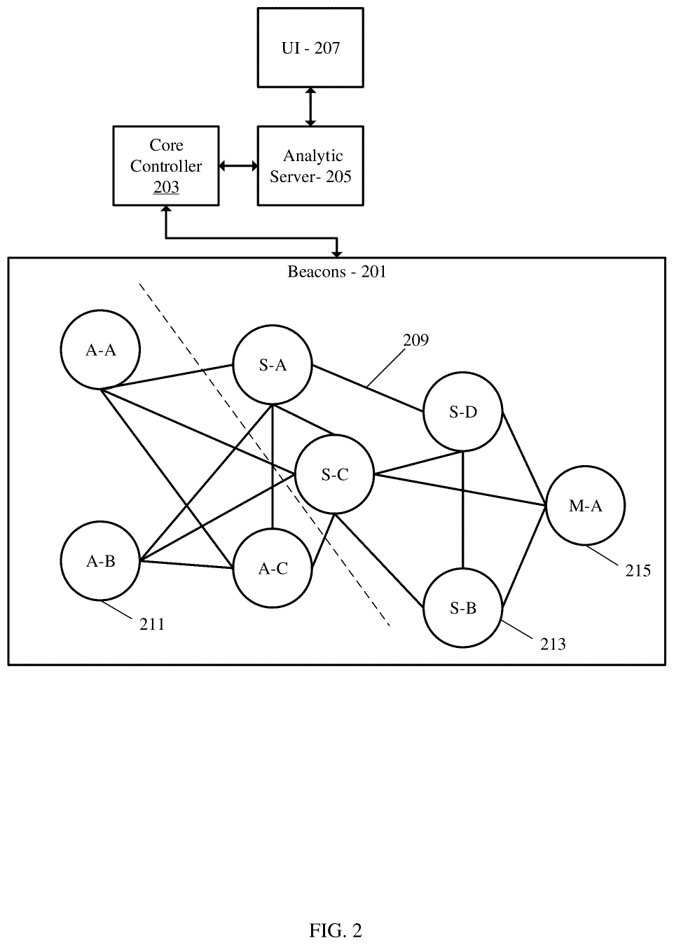

The beacons (e.g., mobile beacons, support beacons, and anchor beacons) perform UWB localization that extends coverage while minimizing localization errors. The beacons can perform iterative localization which can divide a processed location into mini-grids based on the sensing technology used. To mitigate location errors and compensate for potential measurement inaccuracies, support beacons can be placed within the mini-grids of an interconnected grid. This framework is shown in more detail in FIG. 2.

Referring now to FIG. 2, a block diagram showing an interconnected grid of beacons controlled by a core controller, in accordance with an embodiment of the present invention.

The beacons 201 have a limited time allocated to get ranging measurements that include board initialization, deinitialization, and ranging session. The beacons 201 can range with a limited number of beacons at any time depending on their operation mode.

The interconnected grid 209 can be controlled with a core controller 203. The core controller 203 can update, maintain, stop, start, the beacons. The core controller 203 can perform these actions by utilizing an analytic server 205 which can employ representational state transfer (REST) application programming interface (API) framework. Users (e.g., administrators, etc.) can communicate with the core controller 203 with a user interface (UI) 207.

The support beacons 213 (e.g., S-A, S-B, S-C, S-D) are beacons 201 that are placed within mini-grids and can act as intermediaries between the anchor beacons 211 (e.g., A-A, A-B, A-C) and the mobile beacons 215 (e.g., M-A). The support beacons 213 can range with anchor beacons 211 and other beacons 201 to deduce their positions based on ranging measurements. The support beacons 213 can be fixed or move. If the support beacons 213 are moved, their inertial sensors detect the change which prompts a reset and initiation to obtain its new location.

The support beacons 213 are designed to exhibit versatile functionality, capable of acting as both initiators and responders, albeit in a singular mode at any given time until their location is inferred. During the subsequent phase of location refinement, support beacons 213 have the capability to operate in both initiator and responder modes, with the flexibility to do so at predefined intervals or on-demand. Once the locations of the support beacons 213 are accurately determined, the support beacons 213 transition to initiator mode, engaging in ranging with relevant mobile beacons 215. Location refinement occurs regularly or is triggered when the support beacon's 213 inertial sensors detect movement. The support beacon 213 then transitions to responder mode, conducting ranging operations with other support beacons and anchors. The integration of heading and acceleration data in this process enables the support beacons 213 to precisely determine the distance it has moved, effectively reducing the search space for ranging candidates and enhancing the overall efficiency and accuracy of the UWB-based indoor localization system.

The mini-grids are a subset of the interconnected grid 209 that connect the support beacons 213, anchor beacons 211, and mobile beacons 215 together. The mini-grids can be separately managed and controlled by the core controller 203.

The mobile beacons 215 are beacons 201 that can move. In an embodiment, the mobile beacons 215 can be integrated to a system (e.g., handheld) that can be easily carried by a person. In another embodiment, the mobile beacons 215 can be equipped with a movement capability that can determine locations of other beacons 201, including other mobile beacons 215. This facilitates a comprehensive and adaptable ranging framework. The mobile beacons 215 can engage in ranging with other beacons to estimate their own location.

The anchor beacons 211 are beacons 201 that are placed within an interconnected grid 209 with known locations. Locations of anchor beacons 211 and layout of the location where the anchor beacons 211 are placed can be predetermined (e.g., through floor maps, blueprints, maps, etc.). In another embodiment, mobile beacons 215 can actively search for the anchor beacons 211 and map the layout of the location. The map can be generated by converting pixel data obtained from sensors of the mobile beacon 215 into ranging measurements.

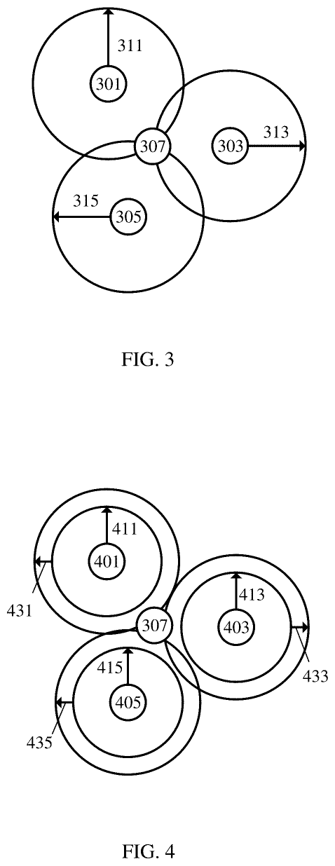

The anchor beacons 211 can provide UWB localization within the interconnected grid 209 but can have limited range as represented by the dashed line in FIG. 2. This is shown in more detail in FIG. 3-4.

The present embodiments employ an optimization process to extend the coverage of the beacons 201 by selecting appropriate locations within the interconnected grid to place support beacons 213 and optimally selecting the appropriate beacon with the updated topology of beacons.

Referring now to FIG. 3-4, a block diagram showing scenarios of coverage range between beacons.

FIG. 3 refers to a block diagram showing a scenario of coverage range between beacons without ranging variance.

The anchor beacons 211, e.g., 301, 303, 305, can transmit pulses up to a certain respective range, 311, 313, and 315. This range can be estimated and measured. Because there are no variance in the estimated ranges, the mobile beacon 307 can localize accurately and derive an optimal location estimate based on the respective ranges of the anchor beacons 211.

FIG. 4 refers to a block diagram showing a scenario of coverage range between beacons with ranging variance resulting in localization errors.

The anchor beacons 211, e.g., 401, 403, 405, can be capable of transmitting pulses up to a certain respective range, 411, 413, and 415, but with respective ranging variances, 431, 433, and 435. This ranging variance can be a result of estimation errors. Because there are variances in the estimated ranges, the mobile beacon 307 can localize with less accurate location prediction.

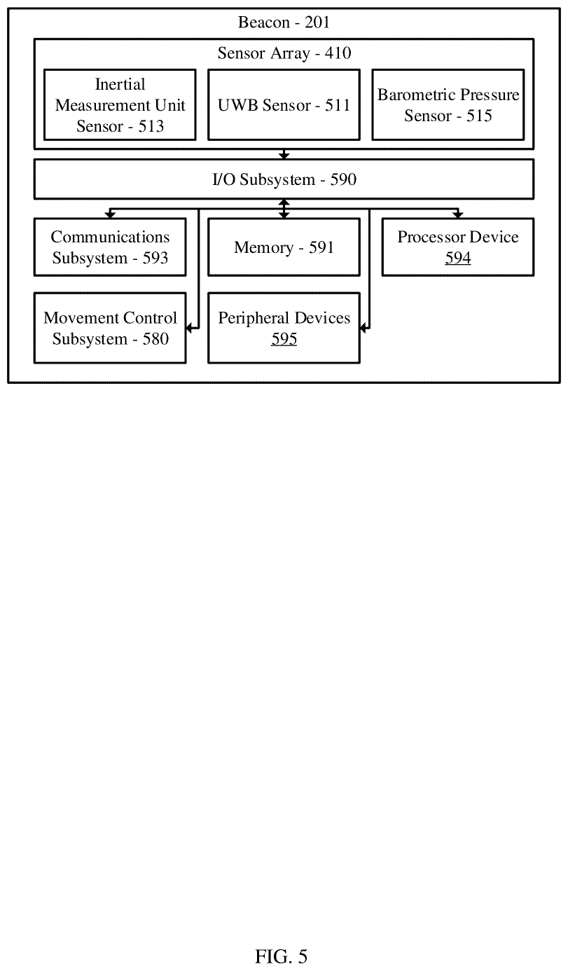

Referring now to FIG. 5, a block diagram showing structures of the beacons, in accordance with an embodiment of the present invention.

The beacon 201 can include a sensor array 410 that can include sensors such as inertial measurement unit sensor 513, UWB sensor 511, barometric pressure sensor 515, etc. The inertial measurement unit sensor 513 can transmit and receive data related to the inertial measurement of the entity that has the sensor. The UWB sensor 511 can transmit and receive ultra-wideband radio signals. The barometric pressure sensor 515 can transmit and receive data related to the barometric pressure around the sensor.

In an embodiment, the beacon 201 can include a movement control subsystem 580 that can move (e.g., on the ground, air, or water) the beacon 201 from one location to another.

The beacon 201 illustratively includes the processor device 594, an input/output (I/O) subsystem 590, a memory 591, a data storage device included in the memory 591, and a communication subsystem 593, and/or other components and devices commonly found in a server or similar beacon. The beacon 201 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 591, or portions thereof, may be incorporated in the processor device 594 in some embodiments.

The processor device 594 may be embodied as any type of processor capable of performing the functions described herein. The processor device 594 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 591 may be embodied as any type of volatile or non-volatile memory or data storage capable of performing the functions described herein. In operation, the memory 591 may store various data and software employed during operation of the beacon 201, such as operating systems, applications, programs, libraries, and drivers. The memory 591 is communicatively coupled to the processor device 594 via the I/O subsystem 590, which may be embodied as circuitry and/or components to facilitate input/output operations with the processor device 594, the memory 591, and other components of the beacon 201. For example, the I/O subsystem 590 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 590 may form a portion of a system-on-a-chip (SOC) and be incorporated, along with the processor device 594, the memory 591, and other components of the beacon 201, on a single integrated circuit chip. The memory 591 can include a data storage device that can include programming code for optimizing latency and coverage for ultra-wideband devices 100.

The communications subsystem 593 of the beacon 201 may be embodied as any network interface controller or other communication circuit, device, or collection thereof, capable of enabling communications between the beacon 201 and other remote devices over a network (e.g., interconnected grid, mini-grid, etc.). The communication subsystem 593 may be configured to employ any one or more communication technology (e.g., wired or wireless communications) and associated protocols (e.g., Ethernet, InfiniBand®. Bluetooth®, Wi-Fi®, WiMAX, etc.) to effect such communication.

As shown, the beacon 201 may also include one or more peripheral devices 595. The peripheral devices 595 may include any number of additional input/output devices, interface devices, and/or other peripheral devices. For example, in some embodiments, the peripheral devices 595 may include a display, touch screen, graphics circuitry, keyboard, mouse, speaker system, microphone, network interface, and/or other input/output devices, interface devices, GPS, camera, and/or other peripheral devices.

Of course, the beacon 201 may also include other elements (not shown), as readily contemplated by one of skill in the art, as well as omit certain elements. For example, various other sensors, input devices, and/or output devices can be included in beacon 201, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the beacon 201 are readily contemplated by one of ordinary skill in the art given the teachings of the present invention provided herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

To establish connections and obtain the locations of the beacons 201, a connection algorithm can be performed. Establishing connections between the beacons 201 and the core controller 203 can be performed with wireless standards such as wireless fidelity (WiFi), sixth generation cellular technology (6G) or long range (LoRa) radio communication protocol.

Referring back now to block 110 of FIG. 1. In an embodiment, locations of anchor beacons 211 and layout of the location where the anchor beacons 211 are placed can be predetermined (e.g., through floor maps, blueprints, maps, etc.). In another embodiment, mobile beacons 215 can actively search for the anchor beacons 211 and map the layout of the location. The map can be generated by converting pixel data obtained from sensors of the mobile beacon 215 into ranging measurements. The connection algorithm can include the following:

```
  1: Drop the beacon at location p(x, y, f) on floor f
  2: px = py = undefined and pf ← f
  3: anchors ← [ ]
  4: status ← UNKNOWN LOCATION
  5: while px and py is undefined do
  6: GET LOCATION(p)
  7: status ← LOCATION FOUND
  8: end while
  9: function GET LOCATION(p)
10: Disable all INITIATOR modes
11: Set the state to RESPONDER in all sensors
12: Reassign with core controller as RESPONDER mode
13: Get nearest neighbors beacons
14: Reprogram the neighbor beacons
15: Run ranging loop neighbors for n measurements
16: Notify the core controller about invalid measurements
17: px,y ← Run trilateration or multilateration on gathered measurements
18: anchors ← neighbors
19: end function
20: end connection algorithm
```

Lines 1-4 sets up the prerequisites of the connection algorithm.

Lines 5-7 show the iterative process of establishing connections to the beacons 201 to obtain the locations of the beacons 201.

Lines 9-19 show specifics on how to obtain location of the beacons 201 in the interconnected grid. In line 14, the beacons 201 can reprogram neighboring beacons by sending instruction code to neighbor beacons 201. This is also shown in block 111. The neighboring beacons 201 can be reprogrammed by changing the configuration settings of the neighboring beacons 201 such as, position in the interconnected grid, position in the topology of beacons, changing status of the beacon to initiator or responder, changing beacon type, etc.

In block 120, a position of the beacons at a discovered area can be refined within a topology having support beacons that fill gaps of coverage between the beacons based on synchronized signal handshakes.

The beacons 201, due to the bidirectional nature of UWB ranging, actively transmit and receive signals that allow synchronized signal handshakes (e.g., mutual agreement of connection between the beacons). The synchronized signal handshakes can include initiation and reception signal transmissions of beacons. Initiating beacons first transmit initiation signals, and responder beacons transmit reception signals upon receiving initiation signals. Responder beacons can be set to initiator beacons to transmit initiation signals. The synchronization mechanism among beacons is required for Time Difference of Arrival (TDoA) which can be measured using the ranging measurements. The beacons can use Two-Way Ranging (TWR), which can eliminate the complex synchronization steps. Due to the nature of the UWB TWR mechanism, a session can be established by programming the source and destination beacons. Ranging measurements can be measured from the beacons with successfully established sessions. If the beacons 201 fail to establish a session, that beacon can be marked as unreachable on the core controller 203.

To refine the location of the beacons 201 a refinement algorithm can be utilized. The refinement algorithm can include:

```
  1: while True do
  2: Reset the state to INITIATOR in all sensors
  3: Register as ANCHOR in the core controller.
  4: Range with Mobile Beacons
  5: new neighbors ← request from core controller
  6: if new neighbors != current neighbors then
  7: current anchors ← new neighbors
  8: Reprogram the neighbor beacons
  9: end if
10: Run ranging loop with current neighbors
11: REFINE LOCATION(p, anchors)
12: end while
13: function REFINE LOCATION(p, anchors)
14: Assign one sensor to RESPONDER mode.
15: Receive a list of beacons new neighbors from
      core controller to range with
16: if new neighbors != anchors then
17: Notify the beacons to run INITIATOR mode
18: Reprogram & Run ranging loop for n measurements
      with new neighbors
19: px,y ← Run multilateration on gathered measurements
20: Adjust location px,y ← px,y
21: anchors ← new neighbors
22: end if
23: Reset mode to INITIATOR mode.
24: status ← LOCATION FOUND
25: end function
26: end refinement algorithm
```

Accessing the reliability of the measurements made to estimate the support beacon location. Sᵢ is the score that the measurements made from the beacon nᵢ is reliable.

$${S}_{i}^{current}$$

is measured from invariability, recentness, and parent reliability score. Invariability can include the percentage of measurements that fall within a set percentage of the threshold thᵢ, (usually within the first standard deviation, a from either mean u or median med of the gathered measurements). Recentness can be based on the last timestamp tsᵢ, when the beacon localized itself. The parent reliability score can be the score of the anchor beacon during previous estimation phase

$${S}_{i}^{prev} .$$

Support beacons 213 can be deployed ad-hoc. The core controller 203 can track the deployed beacons with their mode of operation and their current locations which can include gaps of coverage between the deployed beacons. To extend the coverage, additional beacons can be deployed as additional area are navigated and discovered. Upon activation, a beacon 201 connects to the core controller 203, retrieves nearby beacons for ranging, and attempts to estimate its location. If no beacons 201 are available for ranging, the beacon 201 continuously polls the core controller 203 until it establishes connections. Once ranging is achieved, the beacon 201 estimates its location and continuously refines it to correct any miscalculations. The optimal location and proximity can be determined and stored. For example, it can be determined that support beacons 213 perform best when deployed within eight to nine meters of the anchors and other support beacons 213 due to the signal attenuation indoors (in Non Line-of-Sight NLoS).

Lines 1-12, show the iterative process of refining locations of the beacons 201. In line 5, the core controller 203 can request additional beacons 201 (e.g., support beacons 213) that can be placed in the topology based on the determined gaps in the coverage of the beacons 201 and fill the gaps in coverage. The core controller 203 can determine the gaps in the coverage of the beacons 201 based on the measurements provided by the beacons 201. In another embodiment, the beacons 201 themselves can determine the gaps in coverage. This is also shown in block 121 in FIG. 1.

Lines 13-25 show the function of refining locations of the beacons 201.

Referring back now to FIG. 1. In block 130, latency and coverage between the beacons can be optimized by prioritizing beacons within the topology based on proximity and signal strength.

To optimize the latency and coverage of the beacons 201, the beacons 201 consider several factors including ranging budget, latency constraints, network topology, historical data of mobile beacon 215 movement patterns.

The ranging budget can be computed based on the capacity of the beacons 201 for concurrent ranging interactions. The ranging budget can be efficiently managed to maximize coverage and accuracy while preventing overload.

The latency constraints can be a pre-defined requirement based on user preference. For example, a user can have an acceptable latency of 1 millisecond (ms). The selection algorithm prioritizes beacons that allow for fast ranging completion, ensuring timely location updates without sacrificing accuracy.

The network topology can be determined by estimating the locations of the beacons while maintaining proximity to the actual position. The network topology can be represented as a graph where the beacons can be represented as nodes and the edges can represent the reachability of the beacons (see FIG. 2) and the measured distance between the beacons. To determine the network topology, the location of the beacons 201 can be divided into multiple smaller grids. The grid size can be determined based on factors such as the operating frequency, accuracy and coverage capabilities of the UWB sensors.

The historical data of mobile beacon 215 movement patterns can be utilized to predict future interactions and proactively select beacons 201 for optimal responsiveness. The prediction can be implemented with a machine learning model such as a neural network that can be trained on the historical data and predict future behavior and movements of the mobile beacons 215.

The optimization process can be implemented in at least two approaches: centralized scheduling, distributed scheduling. In centralized scheduling, the core controller 203 orchestrates ranging interactions and dynamically assigning tasks to beacons 201 based on the consideration factors described herein. In distributed scheduling, the beacons 201 can perform localized decision-making, selecting targets for ranging based on heuristics and local information exchange. This is more adaptable to a dynamic network. In an embodiment, the optimization can be implemented using either centralized scheduling or distributed scheduling. In another embodiment, the optimization algorithm can be implemented with a hybrid approach of centralized scheduling and distributed scheduling.

To optimize the latency and coverage of the beacons 201, an optimization algorithm can be performed. The optimization algorithm is shown below.

```
  1: function BEACONSELECTOR(Graph G,
      numBeacons, criteriaFunction)
  2: // Initialize sets for current and next beacons
  3: NOW ← Request beacons from core controller to range
  4: NEXT ← { }
  5: while True do
  6: STARTRANGING(NOW)
  7: inertial data ← GATHERINERTIALDATA(NOW)
  8: ranging results ← range measurements from L-6
  9: // Analyze the ranging results
10: reachable beacons ← {beacon ∈ NOW | valid measurements}
11: unreachable beacons ← {beacon ∈ NOW | RANGE IS NULL }
12: UPDATE graph with ranging connections
13: filteredBeacons ← {beacon ∈ reachable beacons |
      criteriaFunction(beacon, inertial data)}
14: NEXT ← filteredBeacons
15: PRIORTIZEBEACONS(NEXT, signal strength, nearest grid)
16: end while
17: end function
18: end optimization algorithm
```

The optimization algorithm utilizes input data including a topology, number of beacons, and the list of beacons 201. The topology of the beacons can include a graph that represents the Euclidean Distance matrix of the location being localized. The graph can be mapped by the beacons 201 beforehand through heuristics that prioritize beacons based on optimality factors that includes beacon type, recency of last measurement, signal strength of the UWB, and reachability of the beacons. In another embodiment, the graph can be generated based on predefined maps of the location being localized.

Lines 3-4 show the initialization phase of the optimization function.

Lines 5-16 show the iterative process of optimizing the latency and coverage of the beacons. In line 5, the beacons 201 can start ranging for neighboring beacons. The ranging measurements can be utilized to request additional beacons 201 (e.g., support beacons 213) that can be placed in the topology based on the determined gaps in the coverage of the beacons 201. The beacons 201 can determine the gaps in the coverage of the beacons 201 based on their measurements which can be shared among them.

Lines 6-8 show measuring data including latency and coverage for the beacons 201.

Lines 10-11 shows determining reachability of the beacons 201 based on sensor data. This is also shown in block 131 in FIG. 1. To determine reachability of the beacons 201, the availability of sensor data and the quality of sensor data can be processed. For example, if beacon A pulses initiator signals but receives no responder signals from beacon B, then beacon B is not reachable through beacon A. A reachability flag can be generated based on the reachability process which can be set to true or false. For the example above, the reachability flag can include “(A, B, false).” The reachability flag can be stored and processed in a database.

Line 13 shows filtering reachable beacons by analyzing ranging results of the position of the beacons. This is also shown in block 133 in FIG. 1. To filter the reachable beacons, the reachability flags can be processed. If the reachability flags contain “false” then that beacon pair is unreachable and can be filtered off.

Line 12 shows updating a topology of the beacons based on the ranging results, and the connections based on the ranging results that includes the ranging measurements and inertial sensor data. This is also shown in block 135 in FIG. 1. To update the topology of beacons, the reachability flags can be processed. If the reachability flags contain “true,” then an edge between the beacons can be generated. In another embodiment, the topology of beacons can be generated by a graph neural network based on the ranging measurements.

Line 15 shows prioritizing beacons representing reachable beacons within the topology of beacons based on proximity and signal strength. This is also shown in block 137 in FIG. 1. To prioritize beacons, a prioritization algorithm can be utilized such as reach, impact, confidence and effort (RICE) scoring, a priority matrix, etc. In another embodiment, the prioritization can be performed by the graph neural network that considers the topology, proximity and signal strength of the beacons.

The present embodiments can refine the locations and optimizing the latency and coverage of beacons through the use of support beacons that are strategically placed within an interconnected grid and optimally selecting the beacons to perform multi-hop localization.

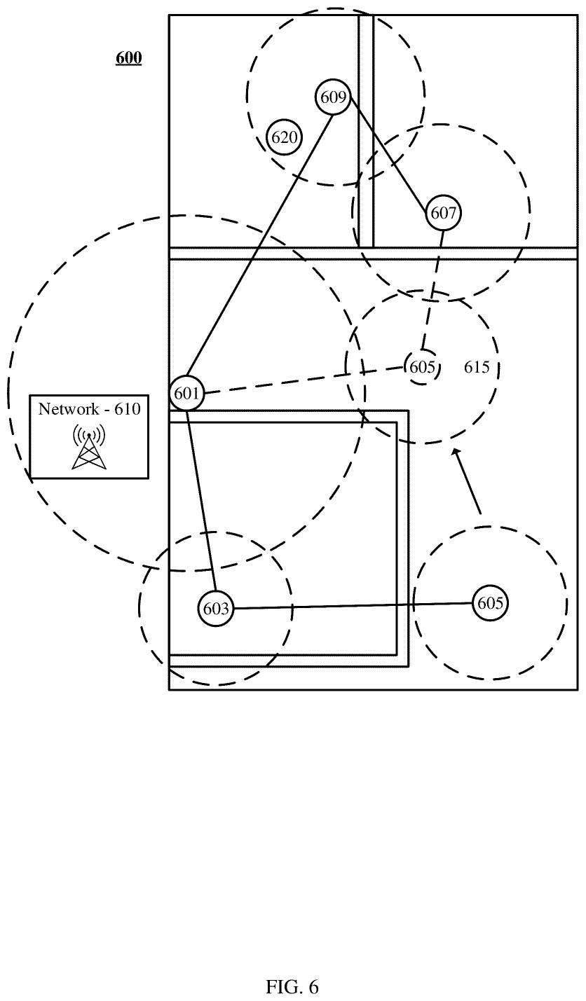

Referring now to FIG. 6, a block diagram showing a system implementing a practical application of extending wireless network connectivity, in accordance with an embodiment of the present invention.

In system 600, the present embodiments can extend wireless network connectivity in a location. The location can be divided into rooms with walls. The location can have a wireless network hub 601 that connects to a network 610 to provide internet connection to the location. The wireless network hub 601 has a limited range which is represented by the circle with dashed lines. Due to this limited range, customer 620 has limited internet coverage.

The location can include beacons 603, 609, 605, and 607. The beacons 201 have limited range which is also represented by a circle with dashed lines. The reachable beacons are represented by the lines connecting the beacons together. Initially, even with the beacons 603, 609, 605, and 607, customer 620 still has limited internet coverage due to the limited range of the beacons 201 that can be caused by the walls and other obstructions.

After refining the location and optimizing the latency and coverage, beacon 605 can move to placement 615 which enables beacon 605 to be reachable by beacon 607 and wireless network hub 601. The reachability of beacon 605 is represented by the dashed lines connecting wireless network hub 601 and beacon 607 to beacon 605. Customer 620 now has better internet connectivity as the device the customer 620 uses can be reached by the network 610 through the beacons. The beacons 201 can also transfer the connection of customer 620 to a better network, a secured connection, or an optimized bandwidth, etc.

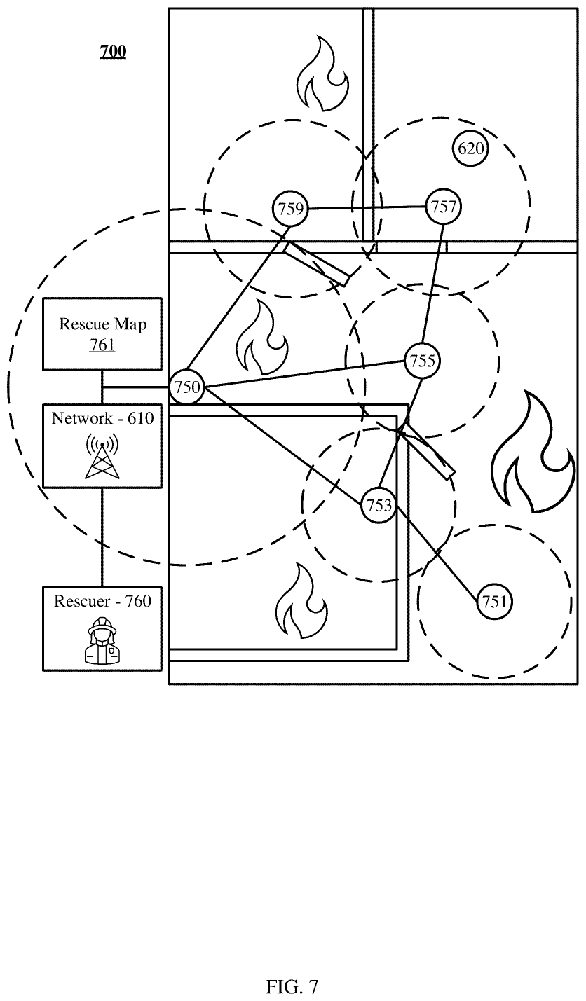

Referring now to FIG. 7, a block diagram showing a system implementing a practical application of rescuing people within a location, in accordance with an embodiment of the present invention.

In system 700, the present embodiments can locate customer 620 in a location. The location can be divided into rooms with walls. The location can have a beacon 750 that connects to a network 610 that can communicate with rescuer 760. The beacon 750 has a limited range which is represented by the circle with dashed lines. The range limits the searching capability of the beacons 201. The location can include additional beacons 751, 753, 755, 757, and 759. The beacons 201 have limited range which is also represented by a circle with dashed lines. The reachable beacons are represented by the lines connecting the beacons 201 together.

The system 700 can generate a rescue map 761 that can be transmitted to the rescuer 760 that provides the optimal path the rescuer 760 can take to safely rescue customer 620. The rescue map 761 can traverse the path generated by beacons 751, 753, 755 and 757. In another embodiment, the rescuer 760 can be an autonomous robot.

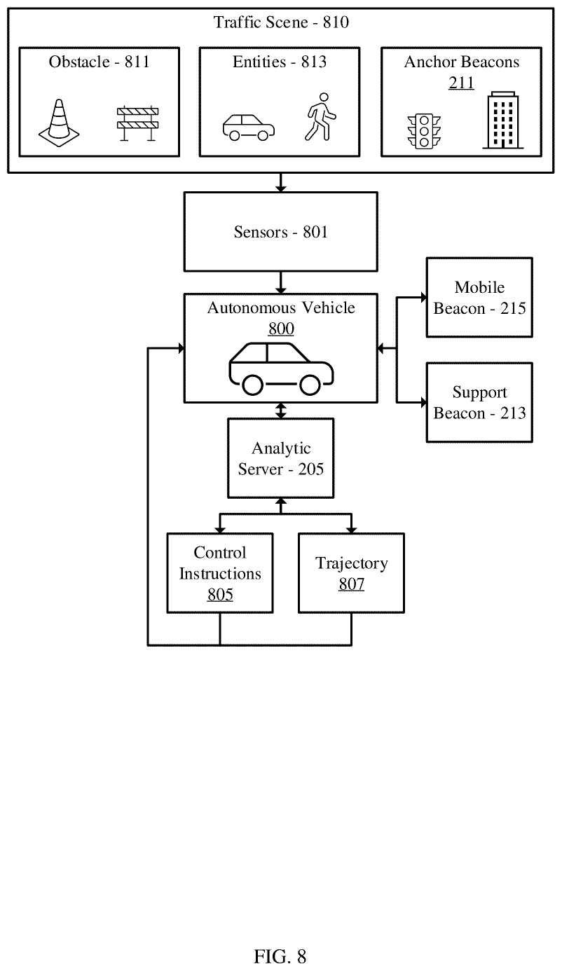

Referring now to FIG. 8, a block diagram showing a system implementing a practical application of controlling an autonomous vehicle, in accordance with an embodiment of the present invention.

Autonomous vehicle 800 can include sensors 801 which can obtain measurement data for a traffic scene 810. The traffic scene 810 can include obstacles 811 (e.g., traffic cones, traffic barriers, traffic signs, etc.), entities 813 (e.g., other cars, pedestrians, etc.) and anchor beacons 211 (e.g., beacons with known locations which can be placed on traffic signs, buildings, etc.). The sensors 801 can include cameras, light detection and ranging (LiDAR), radio detection and ranging (RADAR), UWB sensors, inertial sensors, barometric pressure sensors, etc.

The measurement data can include data for the beacons that includes data utilized by sensors 801 such as UWB data, inertial data, images, barometric pressure data, point-cloud data, radio signals, etc.

The autonomous vehicle 800 can perform processing as a mobile beacon 215 which can range with other beacons within the traffic scene 810 (e.g., anchor beacons 211, support beacons 213, mobile beacons 215). In another embodiment, the autonomous vehicle 800 can perform processing as a support beacon 213 which can extend range with other beacons 201 within the traffic scene 810. The beacons 201 can process the measurement data to optimize the trajectory that the autonomous vehicle 800 can take.

The measurement data can be processed by the analytic server 205 which can generate control instructions 805 and trajectory 807. The control instructions 805 can control the autonomous vehicle 800 using the trajectory 807 that can optimally move the autonomous vehicle 800 through the traffic scene 810 that can avoid obstacles 811 and entities 813 while ensuring safe speed, comfort, and budget constraints (e.g., gas, comfort, battery range, etc.). The autonomous vehicle 800 can include control mechanisms such as autonomous acceleration, direction control, braking, advanced driving assistance systems (ADAS), etc. Other practical applications are contemplated.

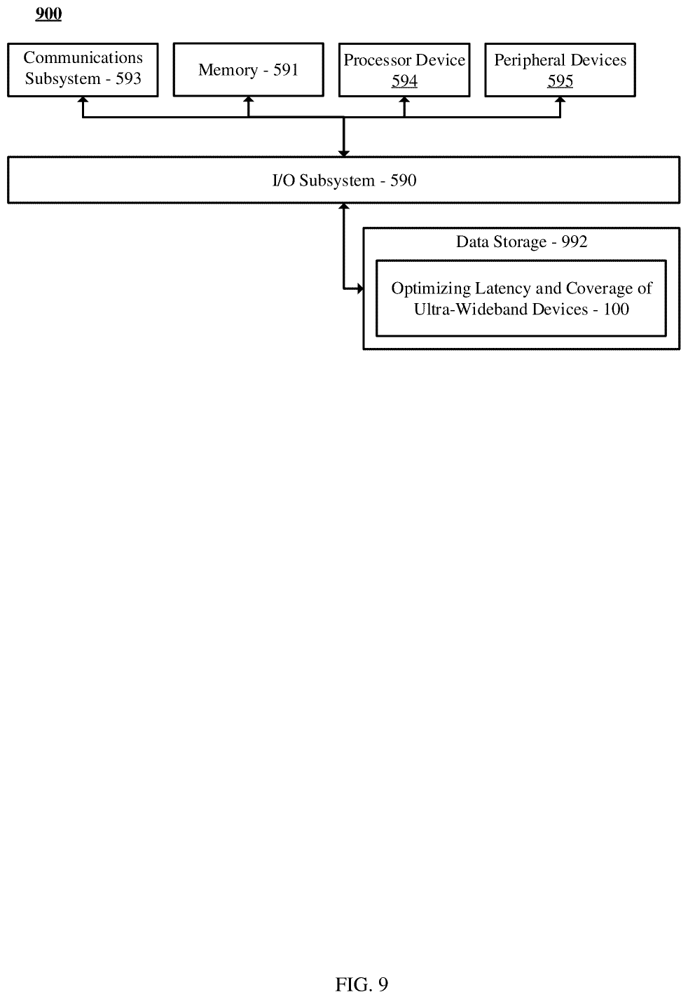

Referring now to FIG. 9, a block diagram showing a system implementing optimizing latency and coverage of ultra-wideband devices, in accordance with an embodiment of the present invention.

Computing system 900 can include communications subsystem 593, memory 591, processor device 594, peripheral devices 595 that can operatively connect to the I/O subsystem 590. A data storage 992 can include program code for optimizing latency and coverage of ultra-wideband devices 100.

The computing system 900 can be implemented as the core controller 203, analytic server 205, or beacons 201. Of course, the computing system 900 may also include other elements (not shown), as readily contemplated by one of skill in the art, as well as omit certain elements. For example, various other sensors, input devices, and/or output devices can be included in computing system 900, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing system 900 are readily contemplated by one of ordinary skill in the art given the teachings of the present invention provided herein.

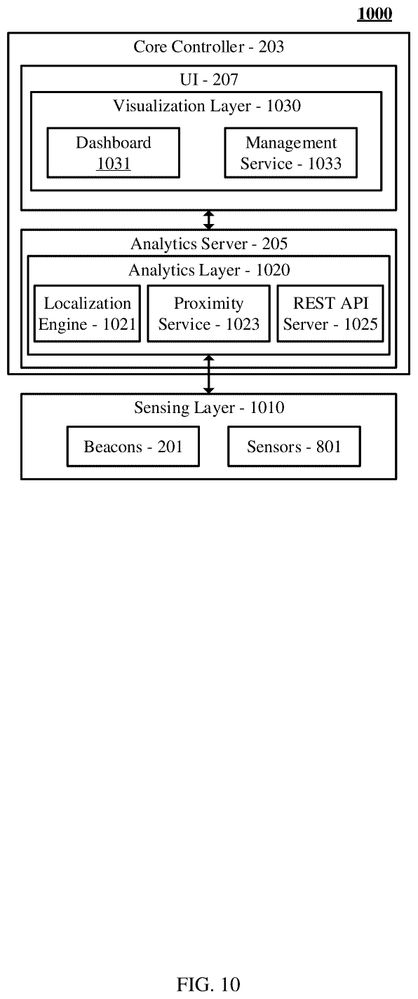

Referring now to FIG. 10, a block diagram showing a multi-layer framework for a computing system for optimizing latency and coverage for ultra-wideband devices, in accordance with an embodiment of the present invention.

The computing system 1000 can implement a multi-layer framework that includes a sensing layer 1010, an analytics layer 1020 and a visualization layer 1030. The multi-layer framework can facilitate easier maintenance, upgrades, and scalability as an end-to-end process by decoupling moving entities from the rest of the system.

The sensing layer 1010 can include the beacons 201 and sensors 801.

The analytics layer 1020 can include a localization engine 1021, proximity service 1023 and a representational state application programming interface (REST API) server 1025. The localization engine 1021 can include instructions and programming code to perform optimization of the coverage and latency of the ultra-wideband devices. The localization engine 1021 can include optimization algorithms for prioritization (e.g., reach, impact, confidence and effort [RICE] scoring; priority matrices), filtering (e.g., Kalman filtering, decision tree-based filtering, etc.). The proximity service 1023 can maintain a history of the beacons and the topology of the beacons on a location which can be used to identify the nearest beacons. The edges in the topology can represent the metric distance between the beacons 201. The proximity service 1023 can employ triangulation, trilateration, multilateration, etc. In another embodiment, the proximity service 1023 can utilize proximity algorithms such as K-nearest neighbors (KNN) searching. The REST API server 1025 can perform operations for the localization engine 1021, the proximity service 1023, the dashboard 1031, management service 1033, and data management for the sensor layer 1010.

The visualization layer 1030 can include a dashboard 1031 and a management service 1033. The dashboard 1031 can include insights showing predictions on the data, the current topology of beacons, and historical data of beacon behavior. In another embodiment, the dashboard 1031 can include predictions for future beacon behavior. The management service 1033 can include services to manage the system including the beacons such as adding beacons, removing beacons, increasing bandwidth for the beacons 201, updating configuration settings, transfer of connectivity protocol, etc. The visualization layer 1030 can interact with the analytics layer to show and perform the changes made through the visualization layer.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for optimizing latency and coverage of ultra-wideband devices, comprising:
establishing connections between beacons through signal transmissions;
refining positions of the beacons at a discovered area within a topology having support beacons that fill gaps of coverage between the beacons based on synchronized signal handshakes; and
optimizing the latency and coverage of the beacons by prioritizing beacons within the topology based on proximity and signal strength.

2. The computer-implemented method of claim 1, further comprises generating a rescue map to rescue a customer in a building using the beacons.

3. The computer-implemented method of claim 1, wherein optimizing the latency further comprises filtering unreachable beacons by analyzing ranging results for the position of the beacons.

4. The computer-implemented method of claim 1, wherein optimizing the latency further comprises determining reachability of the beacons based on sensor data.

5. The computer-implemented method of claim 4, wherein optimizing the latency further comprises updating a topology of beacons based on the reachability of the beacons.

6. The computer-implemented method of claim 5, wherein optimizing the latency further comprises prioritizing beacons representing reachable beacons within the topology of beacons based on proximity and signal strength using a prioritization algorithm.

7. The computer-implemented method of claim 1, wherein establishing the connections further comprises reprogramming neighbor beacons connected to a mobile beacon.

8. A system for optimizing latency and coverage of ultra-wideband devices, comprising:
a memory device;
one or more processor devices operatively coupled with the memory device to perform operations including:
establishing connections between beacons through signal transmissions;
refining positions of the beacons at a discovered area within a topology having support beacons that fill gaps of coverage between the beacons based on synchronized signal handshakes; and
optimizing the latency and coverage of the beacons by prioritizing beacons within the topology based on proximity and signal strength.

9. The system of claim 8, further comprises generating a rescue map to rescue a customer in a building using the beacons.

10. The system of claim 8, wherein optimizing the latency further comprises filtering unreachable beacons by analyzing ranging results for the position of the beacons.

11. The system of claim 8, wherein optimizing the latency further comprises determining reachability of the beacons based on sensor data.

12. The system of claim 11, wherein optimizing the latency further comprises updating a topology of beacons based on the reachability of the beacons.

13. The system of claim 12, wherein optimizing the latency further comprises prioritizing beacons representing reachable beacons within the topology of beacons based on proximity and signal strength using a prioritization algorithm.

14. The system of claim 8, wherein establishing the connections further comprises reprogramming neighbor beacons connected to a mobile beacon.

15. A non-transitory computer program product comprising a computer-readable storage medium including a program code for optimizing latency and coverage of ultra-wideband devices, wherein the program code when executed on a computer causes the computer to perform operations including:
establishing connections between beacons through signal transmissions;
refining positions of the beacons at a discovered area within a topology having support beacons that fill gaps of coverage between the beacons based on synchronized signal handshakes; and
optimizing the latency and coverage of the beacons by prioritizing beacons within the topology based on proximity and signal strength.

16. The non-transitory computer program product of claim 15, further comprises generating a rescue map to rescue a customer in a building using the beacons.

17. The non-transitory computer program product of claim 15, wherein optimizing the latency further comprises filtering unreachable beacons by analyzing ranging results for the position of the beacons.

18. The non-transitory computer program product of claim 15, wherein optimizing the latency further comprises determining reachability of the beacons based on sensor data.

19. The non-transitory computer program product of claim 18, wherein optimizing the latency further comprises updating a topology of beacons based on the reachability of the beacons.

20. The non-transitory computer program product of claim 19, wherein optimizing the latency further comprises prioritizing beacons representing reachable beacons within the topology of beacons based on proximity and signal strength using a prioritization algorithm.
